(19) United States
(12) Patent Application Publication
(10) Pub. No.: US 2007/0139271 A1
(43) Pub. Date: Jun. 21, 2007

(54) Method for access to a medium by a multi-channel device

(75) Inventor: Heiko Pelzer, Erkelenz (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/598,179

(22) PCT Filed: Feb. 22, 2005
(86) PCT No.: PCT/IB05/50635

§ 371 Date: Aug. 21, 2006

(30) Foreign Application Priority Data
Feb. 25, 2004 (EP) 04100737.8

(51) Int. Cl. H01Q 1/38

(52) U.S. Cl. 343/700 MS; 343/702

(57) ABSTRACT

The invention relates to an antenna module for use in hand-held communication devices with two antennae designed to operate both in the GSM and the UMTS frequency bands. In order to realize a particularly small device it is suggested to use two dielectric block antennae (DBA) working in different frequency ranges. This type of antenna comprises a dielectric substrate with a first and a second metallic resonator structure printed on its surface and is basically known from EP 1 289 053 A2. Using two antennae reduces the total volume and consequently the mass in comparison to the case if only one antenna (DBA) is used. At the same time the radiation performance is improved. Additionally the design freedom is increased because the relative positions of the antennae are nearly independent. Furthermore the invention relates to a method to operate a telecommunication device with two antennae, in which the signal of a radio frequency generator is transferred via a power control unit to both antennae at the same time. This approach saves energy and minimizes the amount of radiation absorbed by the user.

The invention relates to an antenna module for use in hand-held communication devices such as mobile phones, data communication cards, for example memory cards for use in labtops and the like, and is particularly suitable for applications belonging both to the second and the third generation of cellular systems.

In mobile telecommunication electromagnetic waves in the microwave region are used to transfer information. An essential part of the telecommunication device is thus the antenna, which enables the reception and the transmission of electromagnetic waves.

Cellular systems of the 2^{nd} generation (GSM) operate in two different frequency bands. In Europe the frequency bands GSM 900, which is located at 880 to 960 MHz, and GSM 1800, located at 1710 to 1880 MHz, are used. Additionally there is the GSM 850 frequency band from 824 MHz to 894 MHz and the GSM 1900 frequency band from 1850 to 1990 MHz mainly used in the United States. Cellular systems of the 3^{rd} generation (UMTS) operate in a frequency band from 1880 to 2200 MHz.

As 2^{nd} and 3^{rd} generation devices will coexist until 2010, current antenna systems must be able to operate both in the GSM and the UMTS frequency band. Bearing in mind that there is a general trend towards miniaturization for telecommunication devices, and that the size of the antennae should not be an obstacle in the way to design a fashionable telecommunication device, the above mentioned task is difficult to achieve.

In general the length of an antenna must be at least a quarter of the corresponding wavelenght. With air as a dielectric medium having a dielectric constant ∈ᵣ of roughly 1, the length must be at least 3.75 cm when the resonance frequency is 2 GHz. Generally known stub-antennae reduce this length by winding the antenna wire around a cylindrical body. However, these external antennae are rather bulky and hardly acceptable for modern designs as they can be seen from outside the device.

Also generally known are Planar Inverted F Antennae (PIFA). These antennae are particularly suitable as internal antennae, as they must be positioned above a grounded metallization. The bandwidth of this type of antenna considerably depends on its height, or rather the distance of its metallic radiating element to the above mentioned metallization. Multi-band telecommunication devices, for example those operating both in the European GSM 1800 band, in the American GSM 1900 band and the UMTS band, need such a bandwidth that the height of the antenna becomes unacceptable. The total volume of such an antenna would be considerably bigger than the volume of current antennae, which means bigger than 35×20×7 mm³. In other words the telecommunication device becomes too bulky, which in turn is an obstacle for the designer to create an aesthetic device.

EP 1 296 410 A1 discloses an antenna system with two planar inverted F antennae. One antenna operates in the GSM band, and one in the UMTS band. A switch is designed to ground the feed point of the first antenna while the second antenna receives or transmits electromagnetic waves. Thus, only one antenna can work at the same time. Referring to the above considerations the overall size of this antenna system is too big for modem designs of hand-held communication devices.

EP 1 289 053 A2 discloses a SMD-antenna with a ceramic substrate on which metallic strip conductors are printed. This printed wire antenna is designed as a dual-band antenna: the width of the strip conductors and their length is so designed as to enable the stimulation both of a fundamental mode and a second harmonic.

It is an object of the invention to provide an antenna module which is particularly small and which poses no obstacle in the design of fashionable hand-held communication devices.

This object is solved by the features of the independent claim. Further embodiments of the invention are described by the features of the dependent claims. It should be emphasised that any reference signs in the claims shall not be construed as limiting the scope of the invention.

According to the present invention the above-mentioned problem is solved by an antenna module for use in hand-held communication devices, which comprises a printed circuit board, a first antenna having a resonance frequency in a first frequency range, a second antenna having a resonance frequency in a second frequency range, whereby each antenna comprises a dielectric substrate with a first and a second metallic resonator structure printed on its surface, the first resonator structure being connected to a feed line, and the second resonator structure, electrically isolated from and adjacent to the first resonator structure, being connected to the printed circuit board for grounding it.

Furthermore the problem is solved by a method to operate a telecommunication device with two antennae, in which the signal of a radio frequency generator is transferred via a power control unit to both antennae at the same time.

The two antennae are of the same type. They both have a dielectric substrate with a large value of the dielectric constant ∈ᵣ. This ensures that the maximum antenna extension lₐ is particularly small, as can be derived from the definition of the fundamental mode f₀ (first harmonic).

$${f}_{0} = \frac{c}{2 {I}_{a} \sqrt{{ɛ}_{r}}} ,$$

With c being the speed of light. In this respect a ceramic material is preferred for the substrate, particularly one having a dielectric constant ∈ᵣ between 2 and 100, preferably in the region of 4 to 25.

The substrate has two resonator structures printed on its surface. These structures are highly conductive, are possibly metallic, and preferably consist of pure silver.

The first resonator structure is an elongated structure which is wound around the dielectric substrate, preferably in the form of a strip conductor. One end serves as a feeding point, and is thus connected via a feed line to the radio frequency (RF) generator. The total length of this first resonator structure determines its fundamental frequency f₀.

The second resonator structure is also an elongated structure which is wound around the dielectric substrate, preferably in the form of a strip conductor. One end is connected to the ground pattern of the application, namely the printed circuit board. The second resonator structure is electrically isolated from and adjacent to the first resonator structure.

The proximity of the two resonator structures is responsible for a capacitive coupling between them. Due to the high permittivity of substrate the coupling between these resonant structures is very high if they are working in the same frequency range. The capacitive coupling leads to a another frequency of the antenna, namely its second harmonic f₁. The exact value of f₁ can be tuned by the distance between the two resonator structures. A larger distance leads to a weaker coupling which shifts the first harmonic towards higher values.

The antennae used within the scope of this invention is called dielectric block antennae (DBA). Further details of this type of antenna, particularly the geometric shape and the material of the resonance structure, the methods to manufacture the resonance structures, and the materials which can be used as a substrate are disclosed in EP 1 289 053 A2 to which this specification explicitly refers to.

The printed circuit board serves for grounding the antennae and has additional electronic parts for the device, such as a power supply, a bleeper, a radio frequency generator, a receiver and the like. It has little or no metallization in the area facing the antennae. In other words the dielectric block antenna is not positioned directly above a grounded metallization. There is a minimum distance between the antenna and the ground metallization depending on the area of the ground metallization parallel to the antenna of at least 2 mm.

The substrate of the antennae can be substantially plane and substantially rectangular. This geometric shape enables a position of the antenna either parallel or vertical to the printed circuit board (PCB). A parallel (vertical) configuration should be understood to be a configuration in which the largest area of the PCB is parallel (vertical) to the largest area of the antenna.

If a parallel configuration is chosen, the antenna can be mounted directly on the printed circuit board by a reflow soldering process. This offers a cheap way to implement the antenna in the application.

When the antennae are vertically aligned with respect to the surface of the printed circuit board only a small area of this surface is covered by the antenna. This means that there are more options to arrange the other electronic parts on the PCB, and/or that the size of the PCB can be reduced. The antennae are preferably located at the top and/or the side of the printed circuit board and can be implemented into the cover of the application by means of snap mounting. Particularly suitable is a spring element implemented in an indentation of the cover where the antennae is snapped in. The conductive resonant structures of the antennae can be contacted by means of spring contacts.

The first antenna has a fundamental frequency f₀¹ (first harmonic) which, for the purposes of this specification, will be called the first resonance frequency. Preferably f₀¹ is substantially in a frequency range of 824 MHz to 960 MHz, which is the frequency band of GSM 850 and GSM 900. Furthermore, the first antenna has a second harmonic f₁¹ approximately twice this frequency, which is the frequency band of GSM 1800 and GSM 1900.

The second antenna has a fundamental frequency f₀² which, for the purposes of this specification, will be called the second resonance frequency. Preferably f₀² is substantially in a frequency range of 1880 MHz to 2200 MHz, which includes the UMTS band.

The first antenna is preferably designed to have a second harmonic which is substantially in a frequency range of 1710 MHz to 2200 MHz. This can be achieved by choosing the length of its first and second resonator structures accordingly, and by tuning the distance between its first and the second resonator structure.

The antennae can be used independently from another. In this case the power of the RF-generator is transferred either to the first or the second antenna, but not to both of them. Thus a control unit is necessary to decide which antenna should be used.

If the telecommunication device, e.g. a telephone, is operating in a cellular system (GSM, UMTS) the transmit frequency of the net provider determines which antenna has to be used. If the provider uses GSM 850/900 or GSM 1800 then the first antenna has to be used. If the provider uses UMTS the second antenna has to be used. Additionally there is an overlap located in the frequency range of GSM 1900 where both antennas can be used.

According to the state of the art the base station regularly emits a signal to the telecommunication device on a microsecond time scale. With this signal the base station communicates the signal strength of the telecommunication device received by the base station. This information is normally used by the device to choose its radiated power accordingly which saves energy.

In the chosen frequency range the control signal of the base station can now be used by a control unit to decide which antenna has a better reception. The control unit can switch between the two antennae according to a predetermined algorithm, and can evaluate the base signal to know which signal strength is better. Correspondingly the antenna with the better reception is used to emit radiation. This mode of operation minimizes the output power of the device which saves energy and leads to less radiation absorbed by the user.

Another possibility to control the use of the antennae is a comparison of the signal level of the two antennae by the above mentioned control unit. In this case the control unit determines the signal strength, and not the base station. The antenna with a higher signal level is then used to emit radiation. In this configuration the antenna module would operate as a (polarisation) diversity antenna module. Again the power consumption and the amount of absorbed radiation is reduced.

As an alternative the two antennae can be used at the same time in the frequency range where both antennae are resonant. In this case the printed circuit board includes a radio frequency generator whose signal is directed to the antennae via a power control unit.

Preferably at least one feed line of the antennae has a phase changer. In this case the phase position of the two antenna signals can be controlled. The phase position largely governs the three dimensional radiation pattern of the device and thus enables a directed transmission. Power consumption and the amount of energy absorbed by the user can be decreased even more in comparison to an operation mode where only one antenna is used at the same time.

In this respect a configuration of the antennae in which the two antennae are orthogonal to each other allows for a control of the radiation pattern which is more flexible and more effective than in a configuration where the two antennae are parallel to each other. Thus the orthogonal configuration is more advantageous than the parallel configuration.

Additionally the separation of the GSM and the UMTS antenna and integrating them into one antenna module enables an enhanced design freedom. The sum of the volumes is much less than the volume of one antenna integrating both systems and both antennas can be placed in a wide range independently. Furthermore a smaller volume means that less material is needed to produce the antennae, and that the weight of the telecommunication device is reduced. The latter aspect is particularly relevant for hand-held devices which can be easily kept in pockets of the user.

These and other aspects of the invention will be apparent from and elucidated with reference to the embodiments described thereafter.

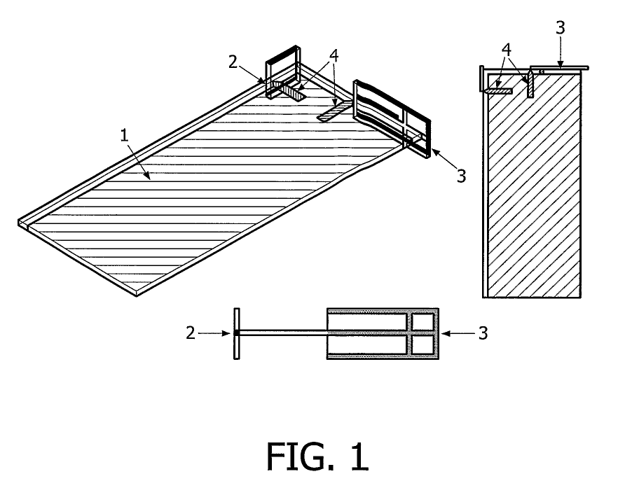

FIG. 1: Diagrammatic representation of an antenna module working in the GSM and the UMTS frequency band, shown in an elevated side view (left) and a top view (right).

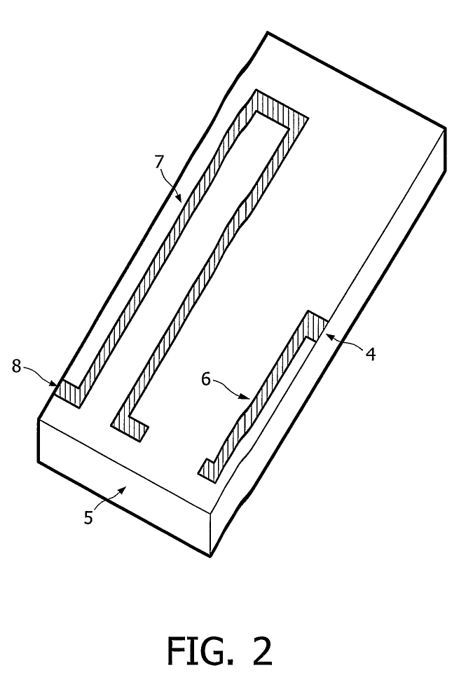

FIG. 2: Diagrammatic representation of a dielectric block antenna.

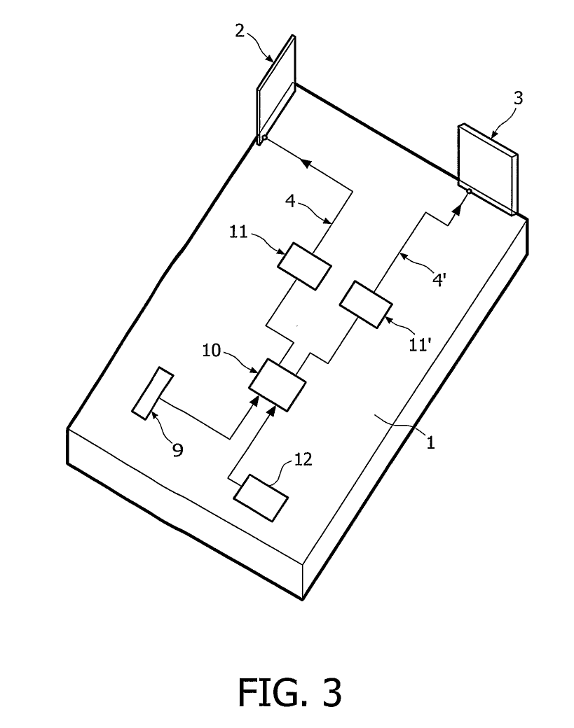

FIG. 3: Diagrammatic representation of the antenna module for simultaneous use of both antennae.

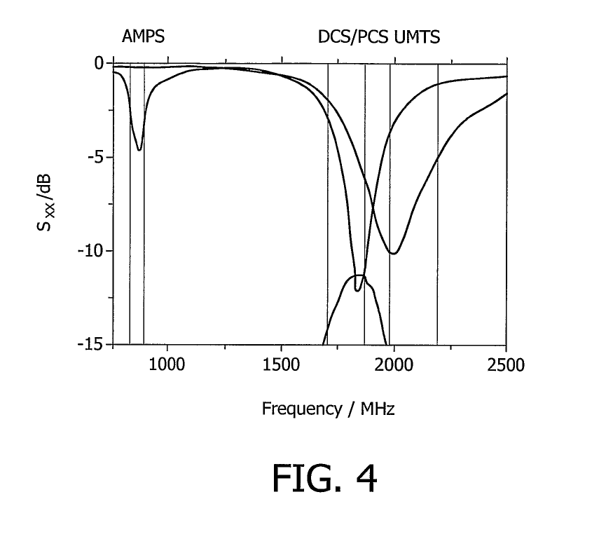

FIG. 4: Scattering parameter for the antenna module with the GSM antenna in the top position and the UMTS antenna located side position, the passive antenna terminated by a 50 Ω resistor.

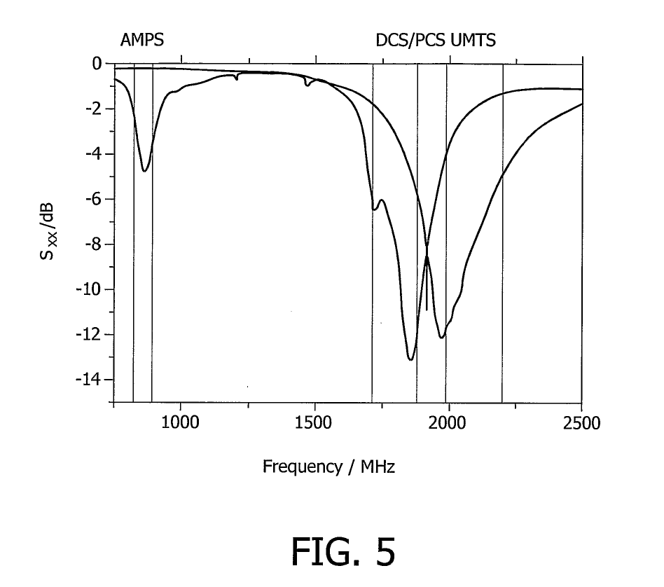

FIG. 5: Scattering parameter for the antenna module with the GSM antenna in the top position and the UMTS antenna located side position, the passive antenna left open.

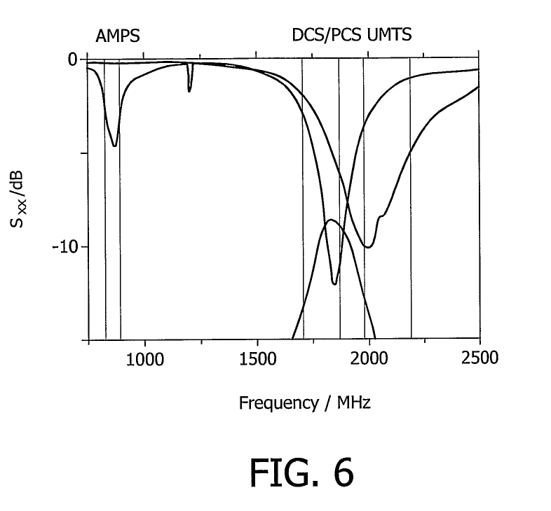

FIG. 6: Scattering parameter for the antenna module with the GSM and the UMTS antenna in the top position, the passive antenna terminated by a 50 Ω resistor.

FIG. 1 shows a first embodiment with an antenna module comprising a printed circuit board 1 having a size of 100×40×1 mm³ and being equipped with a ground metallization (not shown). The board 1 consists essentially of a dielectric substrate with ∈ᵣ=20 with a single layer of microstrips.

The printed circuit board 1 has a first antenna 2 for the UMTS frequency band at the left side of the board. This first antenna has a size of 11×11×1 mm³ and is connected to a RF generator (not shown) by means of a 50 Ω feed line 4. A second antenna 3 with a size of 24×11×1 mm³ is located at the right top edge of board 1. Antenna 3 is connected to the RF generator by a 50 Ω feed line 4. There is no metallization on the board where it faces the antennae. Both antennae are dielectric block antennae as described above.

FIG. 2 shows a principal sketch of a dielectric block antenna (DBA). The DBA is plane and substantially rectangular. The surface of the ceramic substrate 5 has a first resonator structure 6 and a second resonator structure 7. The end of the first resonator structure 6 is connected to a 50 Ω feed line 4. The end point 8 of the second resonator structure 7 is connected to ground. The resonator structures 6, 7 consist of a highly conductive silver metallization which had been printed on the substrate 5.

FIG. 3 shows the antenna module in a configuration in which both antenna can be used at the same time. The printed circuit board 1 has two antennae 2, 3 which are vertically aligned with respect to the surface of board 1. A power control unit 10 directs the signal of the radio frequency generator 9 to the antennae 2, 3 via feed lines 4, 4′. In this way the total RF power is distributed between the two antennae. The phase of the individual signals received by the antennae 2, 3 is actively controlled by phase changers 11, 11′.

Board 1 further includes a unit 12 capable to compare the strength of the signals received by the antennae. In the simplest case only the antenna with the higher signal strength is chosen to emit radiation. This information is transferred to and used by power control unit 10 to distribute RF power.

FIG. 4 is a plot of the scattering parameter sₓₓ of the antenna module as a function of frequency f. In this resonance spectrum s₁₁ (solid line) represents the scattering parameter of the GSM antenna, s₂₂ (dashed line)the scattering parameter of the UMTS antenna, and s₁₂ (dash-dottet line) the transmission from the GSM antenna to the UMTS antenna and vice versa. The measurement was done in a configuration in which only one antenna was used at the same time. The passive antenna was terminated with a 50 Ω resistor.

As can be seen from FIG. 1 s₁₁ has two pronounced dips in the GSM 850 and the GSM 1800 frequency band, and s₂₂ a resonance in the UMTS frequency band. The isolation of the two antenna, represented by s₁₂, is better than −11.5 dB. The impedance match in the upper frequency range is better than −4 dB.

The resonator dips of the two antennae overlap in the frequency range of the GSM 1900 band. In this frequency band the antenna can be used as a diversity antenna module or as an antenna array.

The transmission s₁₂ between the two antennae in the overlap region at around 1900 MHz is remarkably low, such that only a small amount of energy is transferred from one antenna to another. This means that the efficiency of the device is high.

FIG. 5 shows principally the same resonance spectrum with the difference that the passive antenna is left open. The solid line was measured when the UMTS antennae was left open, the dashed line was measured when the GSM antenna was left open. This measure improves the impedance match in upper frequency range which is now better than −5 dB.

Changing the termination of the passive antenna from 50 Ohm to open improves the efficiency of the active antenna in the upper frequency range (DCS/PCS/UMTS) between 5 and 10%. One reason for this improvement is the better matching in this frequency range, due to the interaction between both antennae, the other reason is given by the reflection of the received energy at the open port of the passive antenna in comparison to the 50 Ohm termination transforming this energy to heat.

In a second embodiment the antenna module of FIG. 1 was used, but the bigger GSM antenna had been relocated to the left top edge of board 1. FIG. 6 shows the scattering parameter when the passive antenna is terminated with a 50 Ω resistor. The resonance spectrum is similar to the one of FIG. 4. As a difference, the isolation is not as good, namely −9 dB in comparison to −11.5 dB.

1. Antenna module for use in hand-held communication devices, comprising—a printed circuit board (1),—a first antenna (2) having a resonance frequency in a first frequency range,—a second antenna (3) having a resonance frequency in a second frequency range, whereby—each antenna comprises a dielectric substrate (5) with a first and a second metallic resonator structure (6, 7) printed on its surface,—the first resonator structure (6) is connected to a feed line (4), and—the second resonator structure (7), electrically isolated from and adjacent to the first resonator structure (6), is connected to the printed circuit board (1) for grounding it.

2. Antenna module according to claim 1, characterized by means for fastening the antennae (2, 3) to a cover of the antennae.

3. Antenna module according to claim 1, characterized by a plane substrate (5) being substantially rectangular.

4. Antenna module according to claim 3, characterized in that the antennae (2, 3) are vertically aligned with respect to the printed circuit board (1).

5. Antenna module according to claim 4, characterized in that the antennae (2, 3)are located at the top and/or the side of the printed circuit board (1).

6. Antenna module according to claim 1, characterized in that the first resonance frequency is substantially in a frequency range of 824 MHz to 960 MHz.

7. Antenna module according to claim 1, characterized in that the second harmonic of the first antenna is substantially in a frequency range of 1710 MHz to 2200 MHz.

8. Antenna module according to claim 1, characterized in that the second resonance frequency is substantially in a frequency range of 1880 MHz to 2200 MHz.

9. Antenna module according to claim 1, characterized in that the printed circuit board (1) includes a radio frequency generator (9) whose signal is directed to the antennae via a power control unit (10).

10. Antenna module according to claim 1, characterized in that at least one feed line (4, 4′) of the antennae includes a phase changer (11, 11′).

11. Antenna module according to claim 1, characterized in that the printed circuit board (1) includes a unit (12) capable to compare the strength of the signals received by the antennae.

12. Method to operate a telecommunication device with two antennae, in which the signal of a radio frequency generator (9) is transferred via a power control unit (10) to both antennae (2, 3) at the same time.

13. Method according to claim 12, characterized in that the strength of signals received by the antennae (2, 3) is compared, and that the power control unit (10) distributes the radio frequency power between the antennae depending on the signal strength.

14. Method according to claim 13, characterized in that the antenna with the higher signal strength is chosen to emit radiation.

15. Method according to claim 12, characterized in that the phase of the signal received by at least one of the antennae is actively controlled.

16. Method to operate a telecommunication device with two antennae, in which the signal of a radio frequency generator (9) is transferred via a power control unit (10) to both antennae (2, 3) at the same time used for operation of an antenna module according to claim 1.
